(19) United States
(12) Patent Application Publication
(10) Pub. No.: US 2007/0246030 A1
(43) Pub. Date: Oct. 25, 2007

(54) Launching device for training dogs

(76) Inventor: Robert R. Steiner, Okeechobee, FL (US)

Correspondence Address: Robert R. Steiner, 5345 SE 64th Terrace, Okeechobee, FL, 34974, US

(21) Appl. No.: 11/410,616

(22) Filed: Apr. 25, 2006

(51) Int. Cl. F41B 3/02

(52) U.S. Cl. 124/17

(57) ABSTRACT

This unit is compact and much smaller than available models. It also operates on an electromagnet like my other model.

The present invention relates to a launching device for training dogs. The device consists of the following components:
There is a base and it holds the pivot.
The pivot holds the 4 riser arms.
The riser arms have a pulley bolted to the top.
There are 4 pieces of rubber tubing that goes through the pulley and is fastened to a vinyl pouch 12″ square.
There is a plastic plate on the top of the vinyl and a metal plate on the bottom that the magnet holds on to until the power from a 12 volt battery is turned off.

The pouch is pushed down to the magnet that holds it by the steel plate and then the rubber tubes are stretched down and a large ring affixed to the end of the rubber tube is hooked onto the 4 knobs that hold the riser arms on. This puts tension on the rubber tubes and when the power is turned off to the magnet, the taught rubber tubes throw the training device out.

### DRAWINGS

FIG. 1—The magnet plate is made of steel and is attached by 4 machine screws to the rest pad and vinyl pouch.

FIG. 2—The rest pad is made of plastic and is held in place by the 4 machine screws that go through the vinyl pouch and into the steel magnet plate.

FIG. 3—The 4 riser arms are made of aluminum and are drilled for the pins and hand knob that hold it onto the Pivot. The riser arms also hold the pulley at the top end for the rubber tubes.

FIG. 4—The Pivot is made of steel in the flat state as shown in FIG. 5 and is bent into the shape shown in FIG. 4..

FIG. 5—(bottom drawing)—The base assembly is fabricated by burning the details out of plate steel and bent as shown. Once the details are bent, they are assembled by welding them all together. The base holds all of the other parts shown in FIGS. 2 through 6 as well as the electronic control box.

FIG. 6—(Photo) This is a picture of the entire assembled launcher.

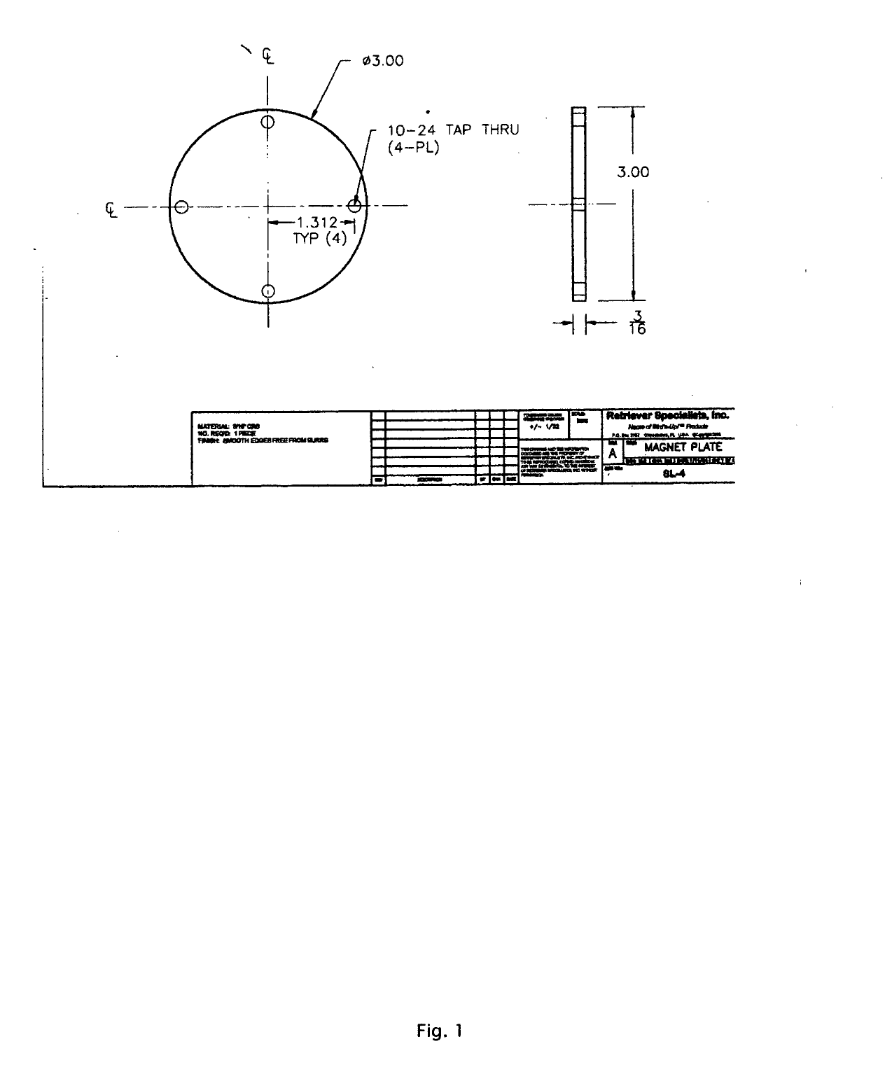

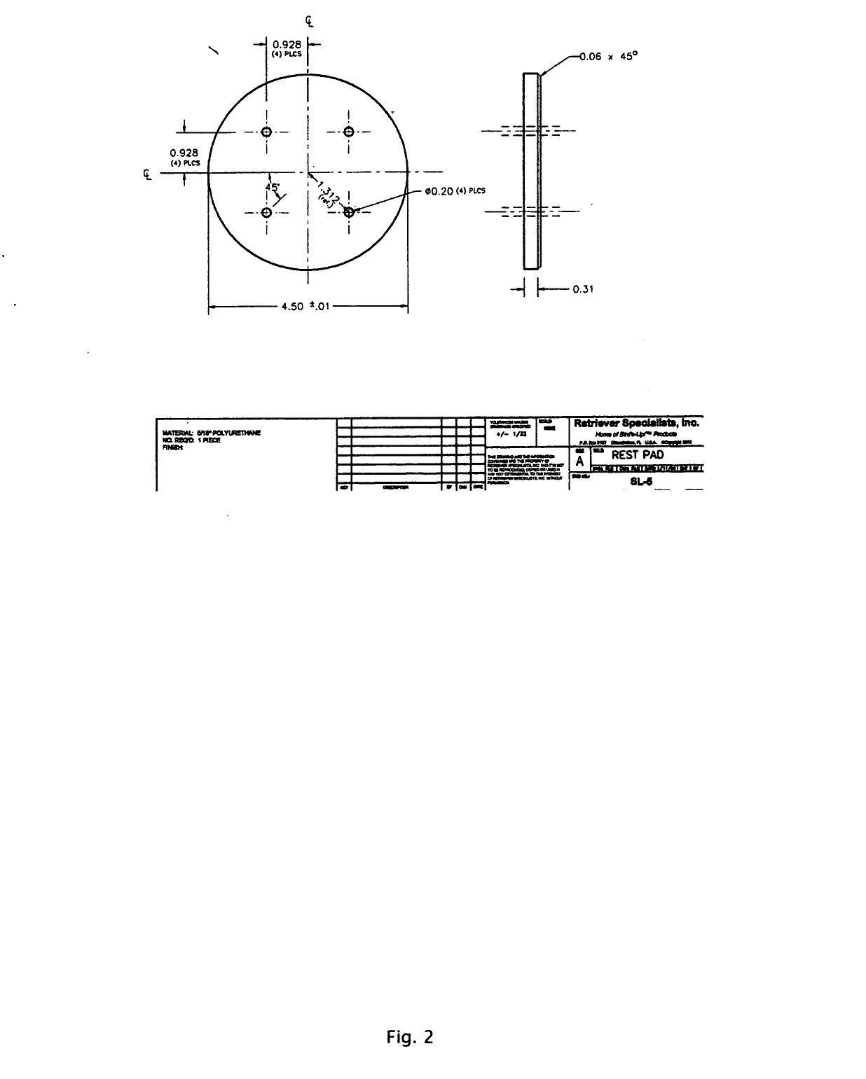

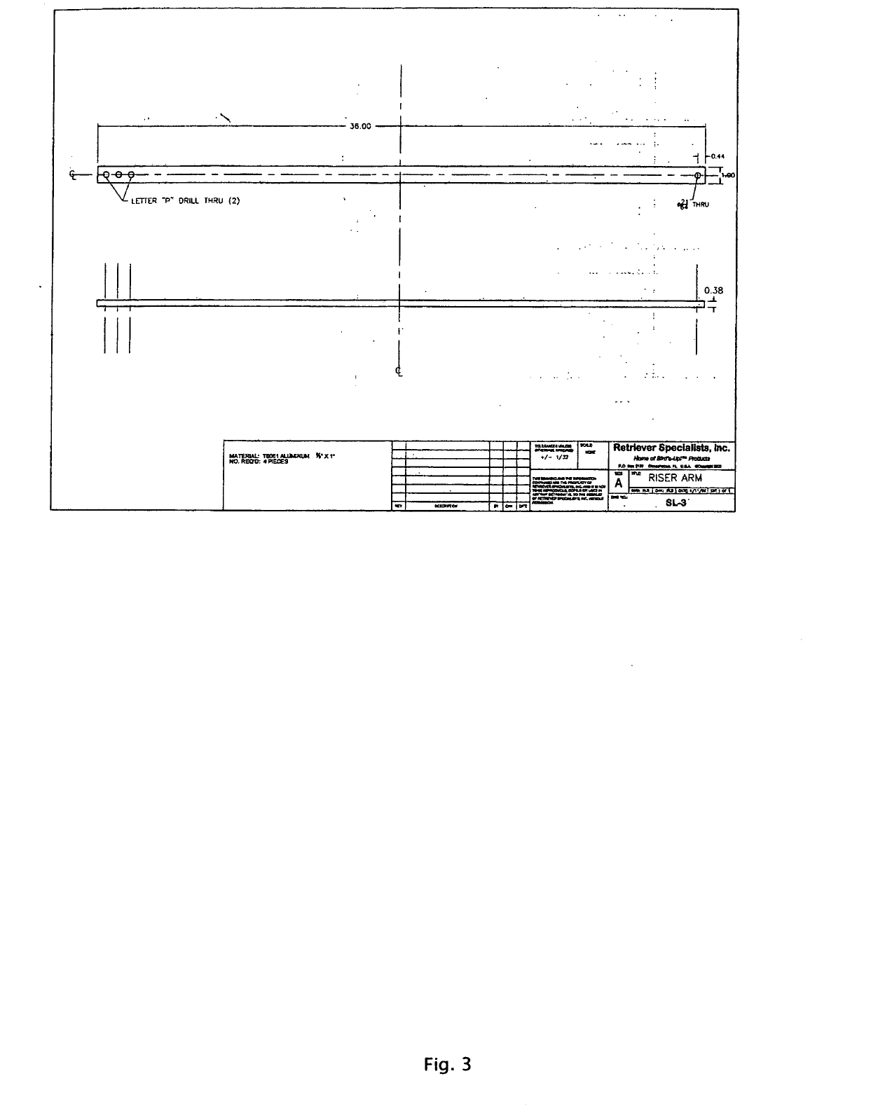

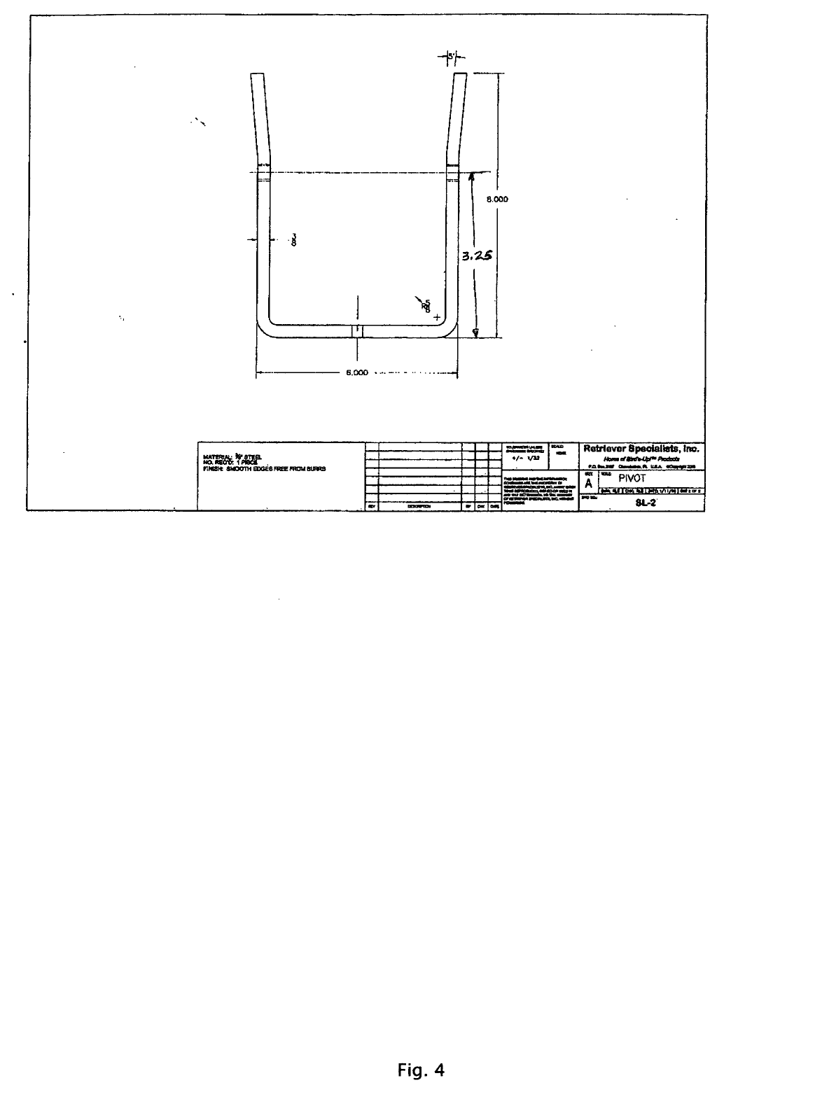

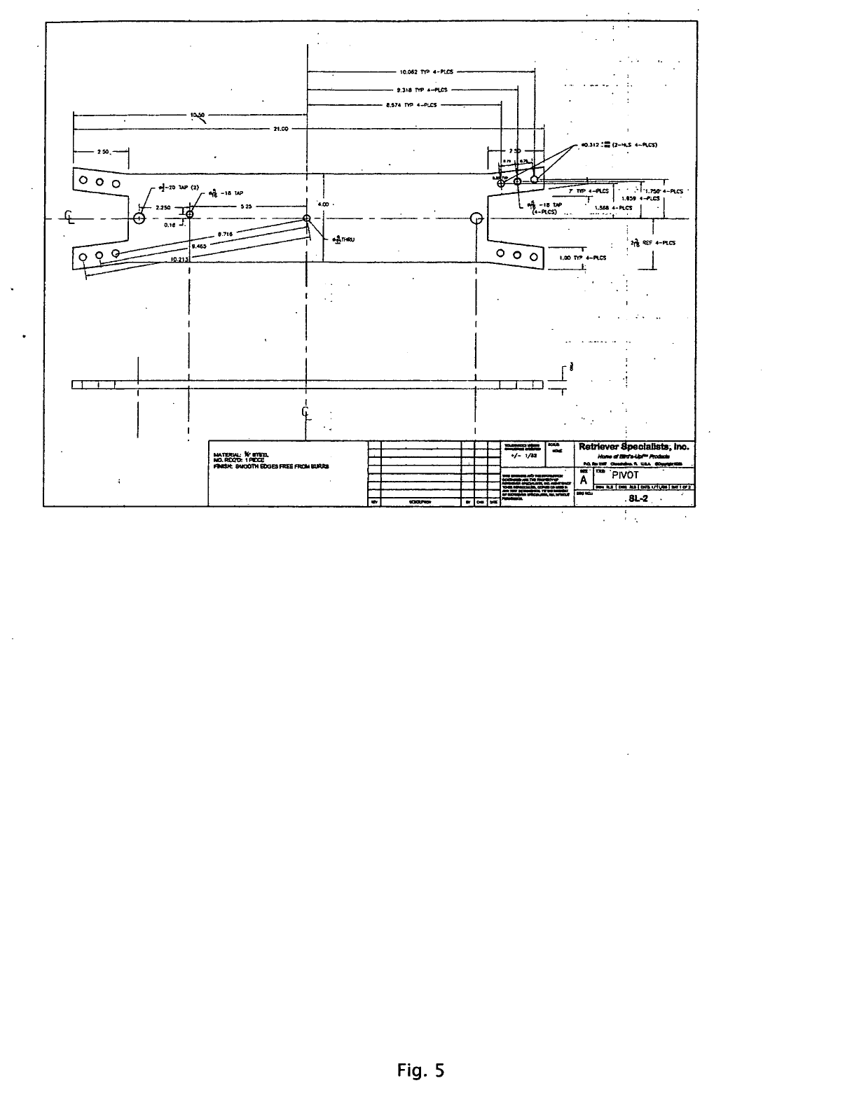

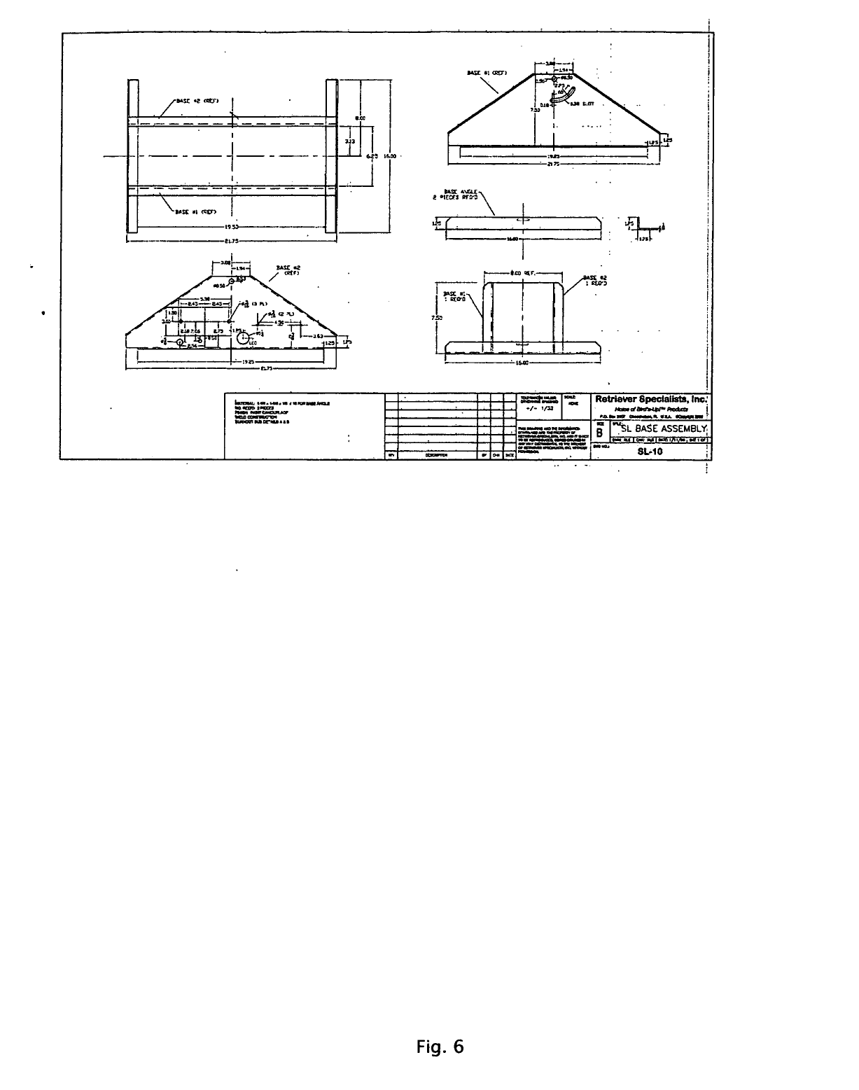

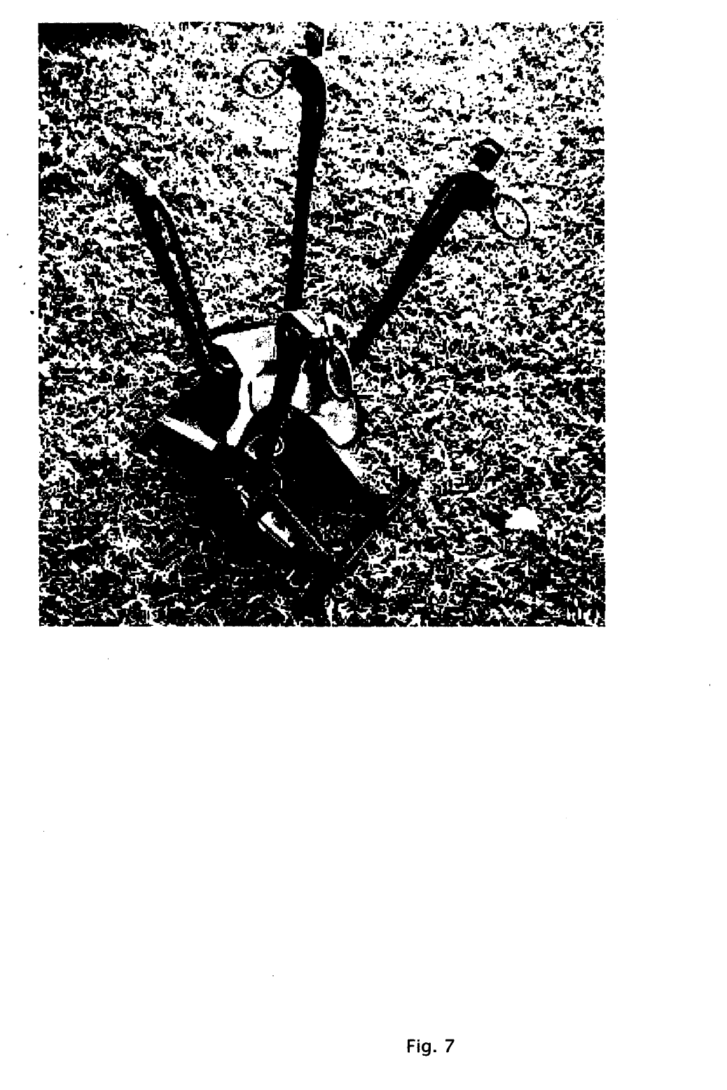

What is claimed is:

1. A launching device for training dogs that holds training bumpers or birds until released to be thrown.
